(19) United States
(12) Patent Application Publication
(10) Pub. No.: US 2022/0329511 A1
(43) Pub. Date: Oct. 13, 2022

(54) Systems and Methods for Restricting the Routing Scope of an Anycast Service

(71) Applicant: Level 3 Communications, LLC, Broomfield, CO (US)

(72) Inventors: John R.B. Woodworth, Amissville, VA (US); Noah Weis, Denver, CO (US); Dean Ballew, Sterling, VA (US); Brian J. Strong, St. Louis, MO (US)

(73) Assignee: Level 3 Communications, LLC, Broomfield, CO (US)

(21) Appl. No.: 17/657,221

(22) Filed: Mar. 30, 2022

Related U.S. Application Data
(60) Provisional application No. 63/171,883, filed on Apr. 7, 2021.

(51) Int. Cl. H04L 45/02; H04L 45/122; H04L 45/12; H04L 45/42; G06K 9/62; G06N 3/04

(52) U.S. Cl. CPC H04L 45/02; H04L 45/122; H04L 45/123; H04L 45/42; G06K 9/6223; G06K 9/6278; G06K 9/6276; G06N 3/04

(57) ABSTRACT

Examples of the present disclosure describe systems and methods for restricting the routing scope of an anycast service. In aspects, network traffic and/or network performance data may be received by a network device and/or an endpoint device in an anycast environment. The received network traffic and/or network performance may be evaluated using one or more automated logic systems or algorithms to identify indicators of potential failure or performance degradation for one or more devices in the anycast environment. Upon identifying one or more such indicators, a routing table of one or more network devices in the anycast environment may be dynamically modified to restrict routes to particular endpoint destinations. The network devices in the anycast environment may subsequently route network traffic according to the modified routing table(s).

### CROSS-REFERENCE TO RELATED APPLICATIONS

This application claims the benefit of U.S. Provisional Application No. 63/171,883, filed 7 Apr. 2021, entitled “Systems and Methods for Restricting the Routing Scope of an Anycast Services,” which is incorporated herein by reference in its entirety.

### BACKGROUND

Anycast is a network addressing and routing method that provides a robust, dynamic, and scalable network framework upon which to run network services. Anycast coordinates route advertisements for an individual destination internet protocol (IP) address being provided by two or more physical, endpoint devices. Routers can determine optimal routing paths for the destination IP address based on known metrics and preferences for each of the physical, endpoint devices. Despite the numerous benefits of anycast, anycast environments are particularly susceptible to cascading device failures caused by denial of service (DOS) attacks.

It is with respect to these and other general considerations that the aspects disclosed herein have been made. Also, although relatively specific problems may be discussed, it should be understood that the examples should not be limited to solving the specific problems identified in the background or elsewhere in this disclosure.

### SUMMARY

Examples of the present disclosure describe systems and methods for restricting the routing scope of an anycast service. In aspects, network traffic and/or network performance data may be received by a network device and/or an endpoint device in an anycast environment. The received network traffic and/or network performance may be evaluated using one or more automated logic systems or algorithms to identify indicators of potential failure or performance degradation for one or more devices in the anycast environment. Upon identifying one or more such indicators, a routing table of one or more network devices in the anycast environment may be dynamically modified to restrict routes to particular endpoint destinations. The network devices in the anycast environment may subsequently route network traffic according to the modified routing table(s). Additionally, endpoint devices in the anycast environment may subsequently adjust the list of network devices to which they advertise according to the modified routing table(s).

In examples, the present application discloses a system comprising at least one processor and memory, operatively connected to the at least one processor, the memory comprising computer executable instructions that, when executed by the at least one processor, cause the system to perform a method. In examples, the method comprises: receiving, at a first device, a message, wherein the message indicates a destination IP address that is an anycast address common between the first device and a second device; evaluating, by the first device, network data to identify one or more indicators of a potential failure or a potential performance degradation of at least one of the first device or the second device; in response to identifying the one or more indicators, identifying one or more network devices associated with at least one of the first device or the second device; identifying one or more routing table modifications to be applied to the one or more network devices based on the one or more indicators; and causing the one or more routing table modifications to be applied to the one or more network devices.

In examples, the present application also discloses a first network device comprising at least one processor and memory, operatively connected to the at least one processor, the memory comprising computer executable instructions that, when executed by the at least one processor, cause the first network device to perform a method. In examples, the method comprises: receiving a message, wherein the message indicates a destination IP address that is an anycast address common between a first endpoint device and a second endpoint device; evaluating the network data to identify one or more indicators of a potential failure or a potential performance degradation of at least one of the first endpoint device or the second endpoint device; in response to identifying the one or more indicators of network behavior, identifying one or more routing table modifications to be applied to a routing table of the first network device, wherein the one or more routing table modifications restrict or remove a route to at least one of the first endpoint device or the second endpoint device; and dynamically applying the one or more routing table modifications to the routing table.

In examples, the present application also describes a method, comprising: receiving, at a first device, a message, wherein the message indicates a destination IP address that is an anycast address common between the first device and a second device; evaluating the network data to identify one or more indicators of a potential failure or a potential performance degradation of at least the first device; in response to identifying the one or more indicators, identifying one or more network devices associated with the first device; identifying a routing table modification to be applied to at least one of the one or more network devices based on the one or more indicators; and stopping, by the first device, advertisement of the destination IP address to the at least one of the one or more network devices based on the routing table modification.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the description which follows and, in part, will be apparent from the description, or may be learned by practice of the disclosure.

### BRIEF DESCRIPTION OF THE DRAWINGS

Non-limiting and non-exhaustive examples are described with reference to the following figures.

FIG. 1 illustrates an example prior art anycast environment.

FIG. 2 illustrates an overview of an example system for restricting the routing scope of an anycast service.

FIG. 3 illustrates an example input processing system for restricting the routing scope of an anycast service.

FIG. 4 illustrates an example method for restricting the routing scope of an anycast service.

FIG. 5 illustrates an example anycast environment incorporating the routing scope restriction techniques described herein.

FIG. 6 illustrates one example of a suitable operating environment in which one or more of the present embodiments may be implemented.

### DETAILED DESCRIPTION

An anycast environment is a network environment in which one or more devices utilize anycast addressing. Anycast addressing enables multiple endpoint destinations/devices to be assigned the same destination internet protocol (IP) address. Routers in the anycast environment use routing logic to determine the “best” route to the destination IP address. The routing logic is based on various routing metrics, such as hop count, path length, path speed, bandwidth, latency, path cost, path reliability, system load, etc. Generally, anycast addressing is highly reliable, due to inherent failover functionality. To wit, anycast services typically feature heartbeat monitoring of endpoint destinations/devices in the anycast environment. When the heartbeat of an endpoint destination/device is undetectable (indicative of device failure or interrupted communication), the advertised route to the endpoint destination/device is withdrawn from one or more routers by the anycast services. The network traffic intended for the undetectable endpoint destination/device is rerouted to detectable endpoint destinations/devices in the anycast environment.

Although this failover functionality may prevent “blackholing” (e.g., transmitting network traffic to a failed or offline device where the network traffic is lost), it also causes anycast environments to be susceptible to particular cyber-attacks, such as denial of service (DoS) and distributed denial of service (DDoS) attacks. A DoS or DDoS attack, as used herein, may refer to a cyber-attack in which an attacker/malicious entity intends to cause a device or network resource to become temporarily or indefinitely unavailable to its intended users by inundating the targeted device or network resource with superfluous network requests (e.g., thereby, causing computational overload on the targeted device or network resource). Although specific reference to DoS and DDoS attacks are discussed, it is contemplated that the systems and methods described herein may be implemented to prevent other types of cyber-attacks and malicious computing-based conduct.

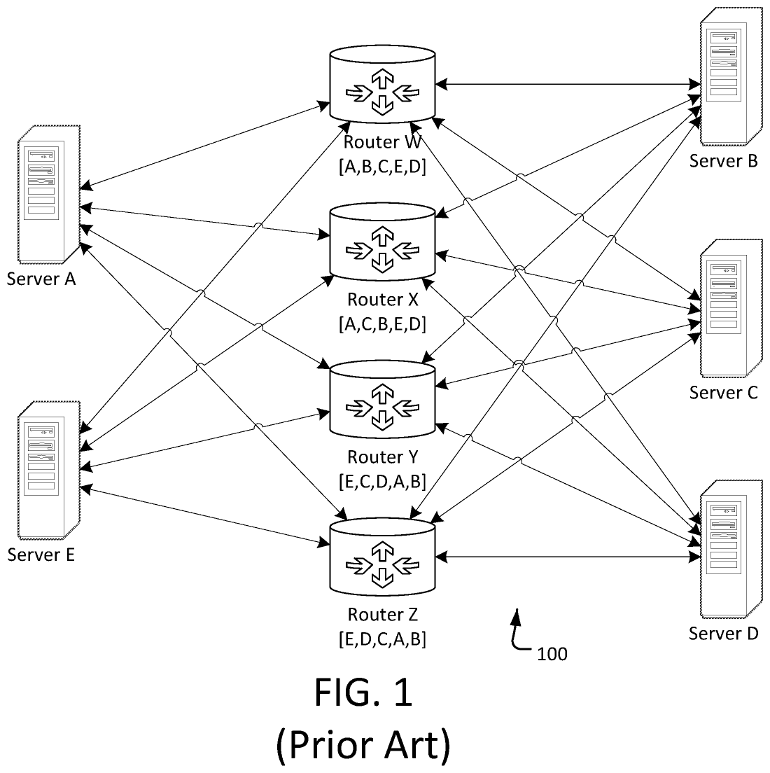

The susceptibility caused by the inherent failover functionality of anycast addressing is demonstrated during a cyber-attack. As a specific example, during a DoS attack, an endpoint destination/device may become unavailable and the advertised route to the endpoint destination/device may be withdrawn. In response to detecting an unavailable endpoint device, the network traffic sent to the destination IP address of the unavailable endpoint device is rerouted to the other endpoint destinations/devices sharing the destination IP address. The rerouting of the network traffic may be dictated by the respective routing tables of the routers in the anycast environment. As each of the routing tables of the routers generally includes many (if not all) of the routes to the endpoint destinations/devices associated with the destination IP address, the network traffic to one or more of the remaining endpoint destinations/devices (e.g., devices for which heartbeats are still detected) may be increased. The additional network traffic and corresponding system load may eventually cause another of the endpoint destinations/devices to become unavailable, which further increases network traffic to and system load of the remaining endpoint destinations/devices. This cascading failure of endpoint destinations/devices may eventually cause all of the endpoint destinations/devices to become unavailable. An example anycast environment in which such a cascading failure may occur is illustrated in FIG. 1.

FIG. 1 depicts an example prior art anycast environment 100. Environment 100 includes servers A-E and routers W-Z. Servers A-E represent endpoint destinations/devices implementing anycast services or applications. In this example, servers A-E are each assigned a common destination IP address. Routers W-Z represent routing devices associated with servers A-E. Routers W-Z each include a respective routing table that comprises routing destinations for each of servers A-E. The routing destinations of each routing table are prioritized according to router logic associated with the corresponding router. For example, the routing table for router W comprises routing destinations for servers A-E that are prioritized in the order: server A, server B, server E, server D, and server C. As such, router W will first attempt to route network traffic for the common destination IP address of servers A-E to server A. If server A is not available, router W will attempt to route the network traffic to server B, and so on. In contrast to router W, the routing table for router X comprises routing destinations prioritized in the order: server B, server C, server D, server A, and server E; the routing table for router Y comprises routing destinations prioritized in the order: server D, server C, server B, server E, and server A; and the routing table for router Z comprises routing destinations prioritized in the order: server E, server A, server D, server B, and server C.

In environment 100, when at least one of servers A-E becomes unavailable, routers W-Z continue to send the network traffic for the common destination IP address to any remaining available server(s) in their respective routing tables. The increased network traffic may eventually cause one or more of the remaining servers to become unavailable; thus, a cascading failure event may occur in environment 100. For example, during a DoS or DDoS attack, router W may receive a large, sustained (for a period of time) volume of network traffic intended for the destination IP address of servers A-E. As the routing table of router W prioritizes server A for the destination IP address, the received network traffic may be primarily (if not entirely) routed to server A. Eventually, the sustained network traffic may overload the connection capacity, CPU, and/or other resources of server A. As a result, server A may become unavailable (e.g., offline or otherwise incapable of accepting network requests). In response to server A becoming unavailable, router W may begin routing the received network traffic of router W primarily (if not entirely) to server B, which is the second server prioritized in the routing table of router W for the destination IP address. Eventually, the sustained network traffic may also overload the connection capacity, CPU, and/or other resources of server B. As a result, server B may also become unavailable. In response to server B becoming unavailable, router W may begin routing the received network traffic to server E. Additionally, as the routing table of router X prioritizes server B for the destination IP address, the received network traffic of router X may be primarily (if not entirely) routed to server C. This pattern of server failure/unavailability and network traffic rerouting may continue until each of servers A-E has become unavailable. Thus, the DoS or DDoS attack is successfully realized.

To address such issues in anycast environments, the present disclosure provides systems and methods for restricting the routing scope of an anycast service. In aspects, network traffic, network performance data, and/or device performance data (collectively, “network data”) may be received by a network device (such as a router) and/or an endpoint device (such as a web server or Domain Name System (DNS) server) in an anycast environment. Network performance data, as used herein, may refer to metrics or data related to the service quality of network, such as bandwidth, throughput, latency, packet loss, retransmission rate, availability, connectivity, etc. Device performance data, as used herein, may refer to metrics or data related to the service quality of a device, such as CPU load, response time, throughput, failure indicators, etc.

The received network data may be identified and/or evaluated using one or more automated logic systems, rule sets, or algorithms, such as machine learning (ML) and/or other artificial intelligence (AI) techniques. Alternately, the received network data may be identified and/or evaluated using a counter- and/or trigger-based mechanism. The evaluation of the network data may identify network behavior that is indicative of the potential failure or performance degradation of one or more devices in the anycast environment. As one example, identified network behavior may indicate a recent surge of network requests received from a geographic region or by one or more network devices. The identified network behavior may also indicate an elevated CPU load or failover messages for one or more endpoint devices advertising to those network devices.

Upon identifying atypical, unexpected, or unacceptable network behavior, a routing table of one or more network devices in the anycast environment may be modified to restrict routes to particular endpoint destinations. The modification of the routing table(s) may be performed dynamically (e.g., substantially in real-time), on-demand, at defined intervals, or upon the fulfilment of other criteria. The modification of the routing table(s) may be performed automatically (e.g., by an ML/AI component of the anycast environment) or manually using an exposed user interface of the anycast environment. In at least one example, the routing table is modified based in part on the routing logic of the network device(s). Restricting the routes may include removing one or more endpoint destinations from the routing table, temporarily disabling one or more endpoint destinations, adding one or more endpoint destinations to the routing table, modifying a priority order of one or more endpoint destinations, modifying one or more routing metrics of the routing table, modifying filtering criteria of the routing table, or the like. In some aspects, in addition to restricting routes to particular endpoint destinations, the lists of network devices to which those particular endpoint destinations advertise may be modified. For example, if a routing table of network device A is modified to remove endpoint destination B, endpoint destination B will cease advertising its availability to network device A.

After a routing table has been modified, the network devices in the anycast environment may subsequently route network traffic according to the modified routing table(s). This alternate routing of network traffic minimizes the exposure of the anycast environment to the cyber-attack scenarios discussed above. Thus, the methods and systems presented herein provide protection from cascading hardware and capacity-based failures by mitigating the scope of advertised routes to a destination IP address when harmful network behavior is detected.

Accordingly, the present disclosure provides a plurality of technical benefits including but not limited to: identifying indicators of potential failure or performance degradation substantially in real-time, identifying possible corrective/mitigation actions using AI/ML techniques, dynamically truncating or restricting routing tables entries, dynamically adding/removing devices from a network, minimizing device exposure in network environments, providing service-level protection in anycast environments, and preventing cascading device failure, among others.

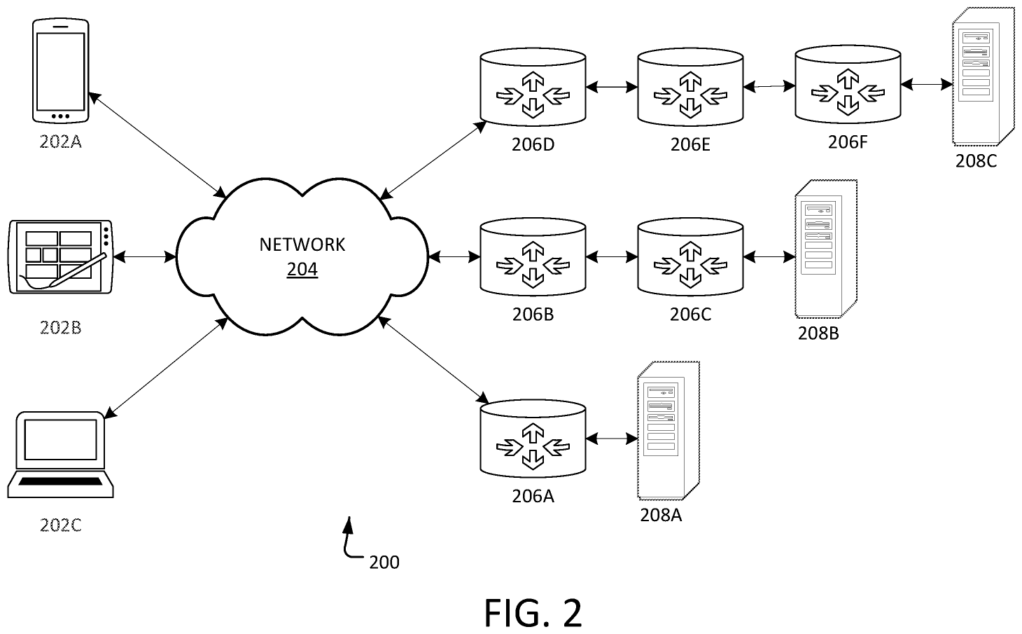

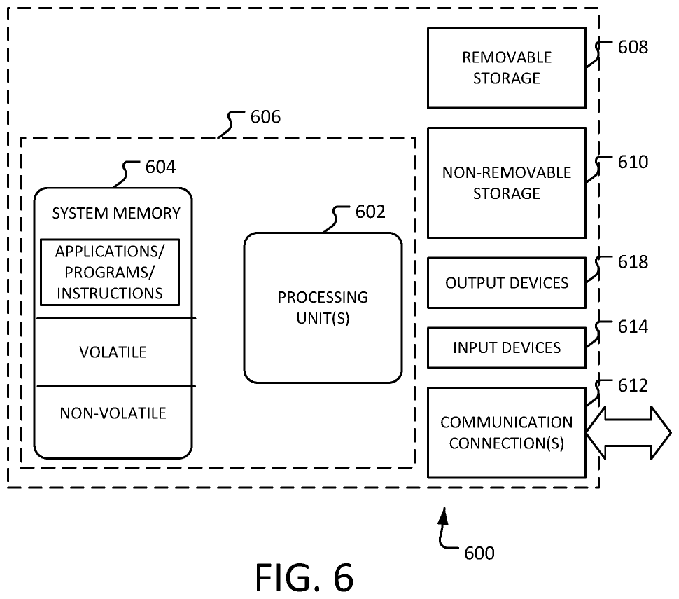

FIG. 2 illustrates an overview of an example system for restricting the routing scope of an anycast service. Example system 200 as presented is a combination of interdependent components that interact to form an integrated system. Components of system 200 may be hardware components or software components implemented on and/or executed by hardware components of the system. System 200 may provide an operating environment for software components to execute according to operating constraints, resources, and facilities of system 200. In one example, the operating environment and/or software components may be provided by a single processing device, as depicted in FIG. 6. In another example, the operating environment and software components of systems may be distributed across multiple devices. For instance, input may be entered on a user device and information may be processed or accessed using other devices in a network, such as one or more network devices and/or server devices.

In FIG. 2, system 200 comprises user devices 202A, 202B, and 202C (collectively “user devices 202”), network 204, network devices 206A, 206B, 206C, 206D, 206E, and 206F (collectively “network devices 206”), and server devices 208A, 208B, and 208C (collectively “server devices 208”). One of skill in the art will appreciate that the scale of systems such as system 200 may vary and may include more or fewer components than those described in FIG. 2. For instance, in some examples, the functionality and components of network devices 206 and server devices 208 may be integrated into a single processing system. Alternately, the functionality and components of network devices 206 or server devices 208 or may be distributed across multiple systems and devices.

User devices 202 may be configured to receive or collect input from one or more users or devices. Examples of user devices 202 include, but are not limited to, personal computers (PCs), mobile devices (e.g., smartphones, tablets, laptops, personal digital assistants (PDAs)), and wearable devices (e.g., smart watches, smart eyewear, fitness trackers, smart clothing, body-mounted devices, etc.). User devices 202 may include sensors, applications, and/or services for receiving or collecting input. Example sensors include microphones, touch-based sensors, keyboards, pointing/selection tools, optical/magnetic scanners, accelerometers, magnetometers, gyroscopes, etc. The collected input may include, for example, voice input, touch input, text-based input, gesture input, video input, and/or image input. At least a portion of the collected input may correspond to a request for data external to user devices 202, such as web resources and other web-based content. Accordingly, user devices 202 may provide the collected input as network traffic to one or more of network devices 206 via network 204.

Network devices 206 may be configured to receive and transmit network traffic to one or more devices based on a network address. Examples of network devices 206 include, but are not limited to, routers, switches, gateways, bridges, route reflectors, repeaters, modems, and hubs. Network devices 206 may comprise respective routing tables and/or routing logic. Each routing table comprises routes to particular network destinations and may comprise routing metrics associated with those routes. A route, as used herein, refers to a path from a source device/network to a destination device/network. The routing logic of a router determines which routes should be used to forward received network traffic to a destination device/network based on any associated routing metrics (if applicable). As one specific example, routing logic of a router may dictate that the route having the fewest hops to the destination device/network should be used to forward received network traffic to the destination device/network. In some aspects, one or more of network devices 206 may be associated with a Border Gateway Protocol (BGP) community. A BGP community, as used herein, refers to an attribute tag that can be applied to a group of network destinations that share a common property. A BGP community identifies BGP community members and can be used to trigger routing decisions for network traffic, such as acceptance, rejection, preference, or redistribution.

Server devices 208 may be configured to receive and transmit network traffic and/or process requests for data. In examples, server devices 208 may be configured for use in an anycast environment. Accordingly, one or more of server devices 208 may implement an anycast service and two or more of server devices 208 may be configured with the same destination IP address. Examples of server devices 208 include, but are not limited to, Domain Name System (DNS) servers, web servers, application servers, and other computing devices storing and/or providing access to web-based content. Upon identifying content that satisfies request for data, server devices 208 may transmit the content to network devices 206 and/or user devices 202. In some aspects, server devices 208 may advertise a network listener IP address. The network listener IP address, as used herein, refers to a listen socket that identifies an IP address, a port number, and/or a server name of a server device. The network listener IP address(es) advertised by server devices 208 may be used to populate the routing tables of network devices 206.

In aspects, one or more of network devices 206 and/or server devices 208 may also be configured to implement or interact with one or more logic components (not pictured). The logic components may incorporate AI and/or ML techniques/tools, such as decision trees, logistic regression, support vector machines (SVM), k-nearest-neighbor (KNN) algorithms, neural networks, Naïve Bayes classifiers, linear regression, k-means clustering, etc. Alternately, the logic components may incorporate counters, triggers, and/or threshold values. In examples, the logic components may be used to evaluate network traffic provided to network devices 206 and/or server devices 208. The evaluation of the network traffic may occur in real-time (e.g., as the network traffic is received), at pre-determined intervals, or on-demand. Based on the evaluation of the network traffic, the logic components may identify indicators of potential failure or performance degradation events in the network traffic. Upon identifying such indicators, the logic components may cause one or more routes in the routing tables of network devices 206 to be removed, restricted, or otherwise modified. Additionally, the logic components may cause server devices 208 to cease advertising a network listener IP address to one or more of network devices 206. In at least one example, the modification of the routing tables occurs dynamically in response to the evaluation of the network traffic. In such an example, the network traffic to one or more of network devices 206 and/or server devices 208 may be throttled or halted in real-time.

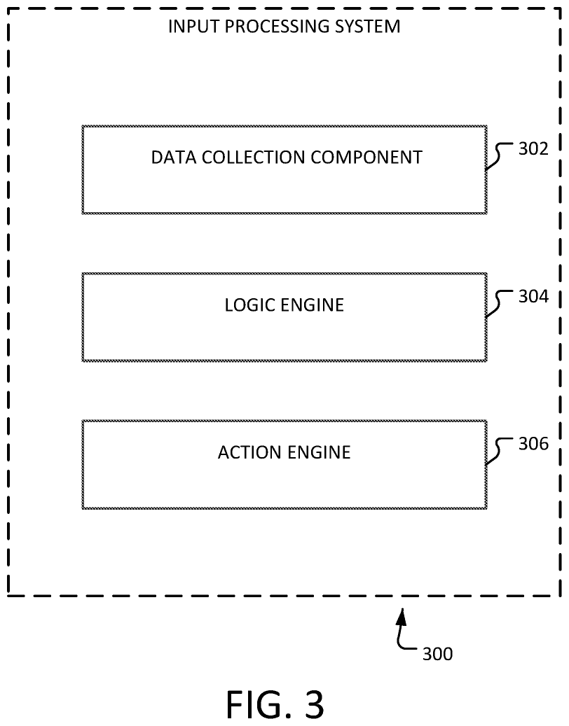

FIG. 3 illustrates an example input processing system 300 for restricting the routing scope of an anycast service as described herein. The techniques implemented by input processing system 300 may comprise the techniques and data described in system 200 of FIG. 2. Although examples in FIG. 3 and subsequent figures will be discussed in the context of anycast environments, it is contemplated that the examples are also applicable to other contexts, such as multicast environments, geocast environments, etc. In some examples, one or more components of input processing system 300 (or the functionality thereof) may be distributed across multiple devices. In other examples, a single device may comprise the components of input processing system 300.

In aspects, input processing system 300 may be implemented in an anycast environment. For example, input processing system 300 may implement an anycast service, implement anycast addressing, or interact with one or more devices that implement an anycast service or anycast addressing. In FIG. 3, input processing system 300 comprises data collection component 302, logic engine 304, and action engine 306. One of skill in the art will appreciate that the scale of input processing system 300 may vary and may include additional or fewer components than those described in FIG. 3. For example, the functionality of logic engine 304 and action engine 306 may be combined into a single component, model, or algorithm.

Data collection component 302 may be configured to detect and/or receive network traffic from one or more devices, such as user devices 202. The network traffic may include one or more data requests comprising audio data, touch data, text-based data, gesture data, video/image data, etc. Detecting the network traffic may include using one or more sensors and/or monitoring utilities of input processing system 300. Upon receiving the network traffic, data collection component 302 may perform one or more processing steps. The processing steps may include, for example, parsing the network traffic to identify user-/device-information (e.g., user/account name, device name/type), identifying network information (e.g., source IP address, destination IP address, hop limit), identifying entry point information (e.g., application or service used to collect the input), identifying date/time information, identifying input attributes (e.g., length of input, subject and/or content of input), storing and/or labeling the input, etc.

Logic engine 304 may be configured to evaluate the received network traffic. In aspects, data collection component 302 may provide the (un)processed network traffic (or access to the (un)processed network traffic) to logic engine 304. Logic engine 304 may receive the network traffic in real-time (e.g., as the network traffic is received/processed by data collection component 302) or according to a pre-defined delivery/access schedule. Logic engine 304 may use at least a portion of the received network traffic to identify whether the received network traffic is indicative of the potential failure or performance degradation of one or more devices in the anycast environment. Identifying whether the received network traffic is indicative of the potential failure or performance degradation may include using AI, ML, counters, triggers, and/or thresholds. As one specific example, one or more counters may be incremented based on indicators in the received network traffic. The counters may be compared to one or more threshold values. Logic engine 304 may classify the received network traffic based on whether the counters meet or exceed the threshold values.

In aspects, indicators of potential failure or performance degradation may be derived by analyzing current network/system data, such as the number of network requests received from a source IP address or geographic region, the number of network requests received by one or more network or endpoint devices, network request trends, the system load of one or more devices, web resource availability, failover and/or imminent failure messages, and network latency, among others. In at least some examples, the current network/system data may be compared to historical or previously collected network data and/or user behavioral data (e.g., login/logout events, search history, detected networks, device geolocation, usage patterns). Indicators of potential failure or performance degradation may be identified when the current network/system data does not match the historical or previously collected network/user behavioral data. When indicators of potential failure or performance degradation are identified, logic engine 304 may identify one or more corrective or mitigation actions based on the indicators. Example corrective/mitigation actions include, but are not limited to, modifying the routing tables of one or more network devices, throttling or pausing network traffic to one or more devices, adding or removing one or more devices from the anycast environment, allocating additional resources to one or more devices, and suppressing advertised destination IP addresses. In some aspects, the corrective/mitigation actions identified may be based, at least in part, on input, rules, or logic from other devices. As one specific example, logic engine 304 may evaluate routing logic and/or preferences of one or more routers associated with one or more endpoint devices in an anycast environment. Logic engine 304 may acquire the routing logic and/or preferences by querying the routers in real-time, accessing stored or cached routing logic and/or preferences, or any other means of acquisition.

Action engine 306 may be configured to perform corrective/mitigation actions. In aspects, action engine 306 may have access to one or more identified corrective/mitigation actions. Upon accessing the identified corrective/mitigation actions, action engine 306 may perform (or cause the performance of) one or more of the corrective/mitigation actions. Performing the corrective/mitigation actions may include executing a set of instructions associated with the corrective/mitigation actions or providing a set of instructions or recommendations associated with the corrective/mitigation actions to one or more devices. As one specific example, action engine 306 may cause one or more routers in an anycast environment to dynamically remove one or more endpoint destinations from their respective routing tables. Such a dynamic removal of endpoint destinations may minimize the exposure of the anycast environment to cyber-attacks, unexpected device failure, abnormal network behavior, and similar events.

Having described various systems that may be employed by the aspects disclosed herein, this disclosure will now describe one or more methods that may be performed by various aspects of the disclosure. In aspects, method 400 may be executed by an example system, such as system 200 of FIG. 2, network device(s) 206, and/or input processing system 300 of FIG. 3. However, method 400 is not limited to such examples. In other aspects, method 400 may be performed by a single device comprising an anycast application or service. In at least one aspect, method 400 may be executed (e.g., computer-implemented operations) by one or more components of a distributed network, such as a web service/distributed network service (e.g. cloud service).

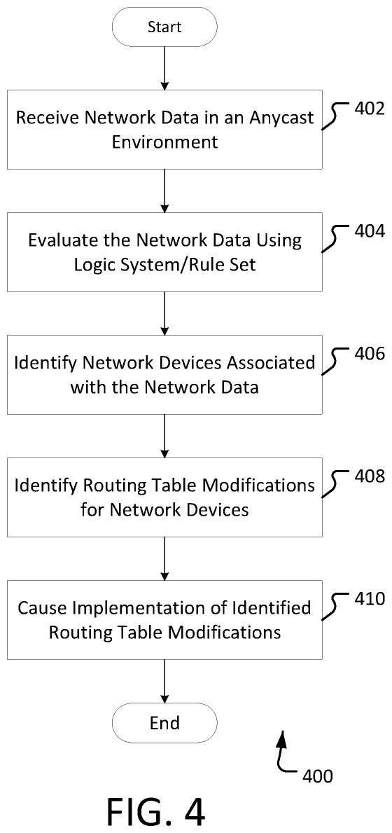

FIG. 4 illustrates an example method 400 for restricting the routing scope of an anycast service. Method 400 begins at operation 402, where network data is received. In aspects, a device in an anycast environment, such as network devices 206 or server devices 208, may receive network data originating from one or more user devices, such as user devices 202. The network data may include network traffic, network performance data, device performance data, user/device identification data, and the like.

At operation 404, the network data may be evaluated. In aspects, the network data may be evaluated using one or more automated logic systems, rule sets, or algorithms. The automated logic systems, rule sets, or algorithms may identify one or more indicators of the potential failure or performance degradation of one or more devices in the anycast environment. As a specific example, a DNS server comprising an ML engine (e.g., an automated logic system, rule set, or algorithm) may receive network data transmitted from one or more routers. The network data may be provided as input to the ML engine. The ML engine may store at least a portion of the network data in a temporary or permanent storage location (e.g., data buffer, cache, data file). Upon receiving a statistically significant amount of network data, the ML engine may evaluate the network data. A statistically significant amount of network data may correspond to, for example, a time period (e.g., 500 milliseconds, 5 seconds, 1 minute) a data amount (e.g., 100 KB, 1 MB, 100 MB), a number of data packets, etc. In the present example, the ML engine may determine that there has been a 1000% increase in network traffic for an anycast endpoint device in the last 30 seconds, the system load of the anycast endpoint device has increased 700% during the 30 seconds, and 98% of the network traffic originates from the same source IP address.

At operation 406, network devices may be identified. In aspects, based on the indicators of the potential failure or performance degradation, the automated logic systems, rule sets, or algorithms may identify one or more network devices associated with the received network data and/or the receiving device. The associated network devices may be identified using various methods. For example, a network trace utility or a network data evaluation utility may be used to detect the devices/network path used to transmit the network data to the receiving device. As another example, the routing tables of one or more network devices may be evaluated to identify network routes associated with the received network data and/or the receiving device. As yet another example, recorded network traffic log entries may be evaluated to determine network devices that have previously been detected by or transmitted network traffic to the receiving device.

At operation 408, routing table modifications may be identified. Upon determining the associated network devices, the automated logic systems, rule sets, or algorithms may determine modifications to implement on the routing tables of the associated network devices. The determination may be based on the indicators of the potential failure or performance degradation. For instance, continuing from the above example, based on the determinations of the ML engine (e.g., 1000% increase in network traffic for an anycast endpoint device, 700% increase in system load, and 98% of the network traffic originates from the same source IP address), the ML engine may further determine that the anycast endpoint device and/or one or more associated anycast endpoint devices should be removed from the route tables of one or more of the associated network devices.

In some aspects, the determination of the automated logic systems, rule sets, or algorithms may be based (at least in part) on the routing logic and/or routing metrics of one or more network devices. As one example, the automated logic systems, rule sets, or algorithms may determine the top ‘N’ or ‘N %’ of network routes listed in the routing tables of the associated network devices for a destination IP address associated with the receiving device. The top ‘N’ or ‘N %’ of network routes may correspond to the prioritization order of the network routes in the respective network devices. The prioritization order of the network routes may be based on routing metrics such as hop count, path length, path speed, bandwidth, latency, path cost, path reliability, system load, etc. The automated logic systems, rule sets, or algorithms may determine that the routing tables should be truncated to remove network routes for the destination IP address that are not within the top ‘N’ or ‘N %’ of network routes. As another example, the automated logic systems, rule sets, or algorithms may identify a group of IP addresses, devices, or geographic regions associated with the associated network devices. For instance, one or more BGP communities may be identified as associated with the associated network devices and/or the receiving device. Based on the BGP communities, the automated logic systems, rule sets, or algorithms may identify BGP community-based restrictions to be applied to the routing tables of the associated network devices.

At operation 410, routing table modifications may be implemented. In aspects, the identified routing table modifications may be provided to one or more users, such as a network or system administrator. The users may manually modify the routing tables of the associated network devices based on the identified routing table modifications. In other aspects, the identified routing table modifications may be provided to one or more associated network devices and such modifications may be made automatically. The associated network devices (e.g., network devices 206) may use the identified routing table modifications to dynamically update their respective routing tables. The associated network devices may provide a response comprising an indication of the success or failure of the update. In yet other aspects, the identified routing table modifications may be used to update a routing table of the receiving device. For instance, a network device comprising the automated logic systems, rule sets, or algorithms may dynamically update a routing table of the network device based on the identified routing table modifications. In still yet other aspects, the identified routing table modifications may be provided to a remote service or application for managing one or more of the associated network devices. The remote service or application may send the associated network devices a set of instruction or command for dynamically updating their respective routing tables. In all such aspects, the dynamic implementation of the identified routing table modifications may prevent or mitigate the adverse impact of cyber-attacks, unexpected device failure, abnormal network behavior, and similar events.

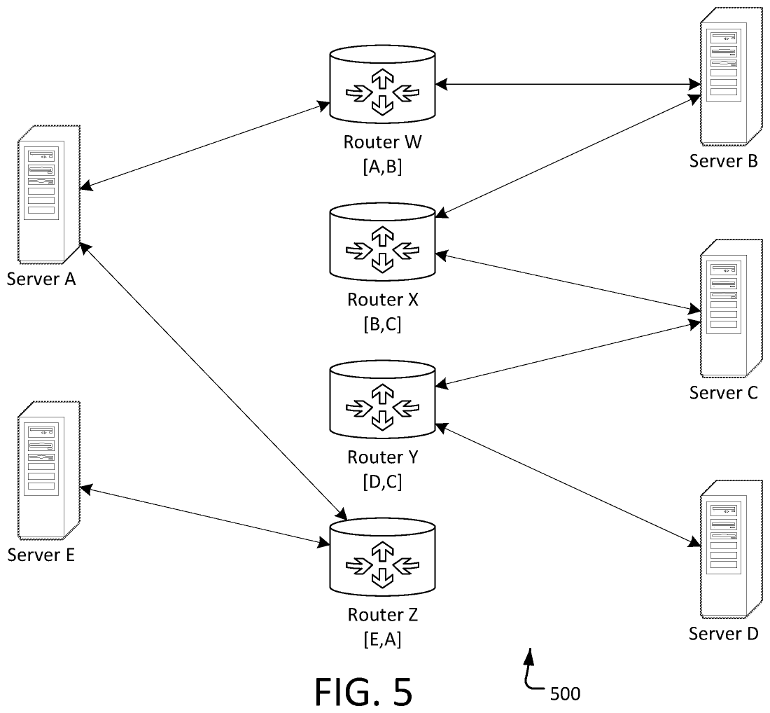

FIG. 5 depicts an example anycast environment 500 incorporating the routing scope restriction techniques described herein. Similar to environment 100 of FIG. 1, environment 500 includes servers A-E and routers W-Z. Servers A-E represent endpoint destinations/devices implementing anycast services or applications. Accordingly, servers A-E are each assigned a common destination IP address. Routers W-Z represent routing devices associated with servers A-E. Unlike environment 100 of FIG. 1, the respective routing tables of routers W-Z of environment 500 have each been modified to include routing destinations for only a subset of servers A-E. The routing table modifications may be performed by a logic component, such as logic engine 304. In some examples, the logic component may be implemented on one or more of servers A-E. The server(s) implementing the logic component may send a command or set of instructions to routers W-Z. The command or set of instructions may instruct routers W-Z to update their respective routing tables. Alternately, the server(s) implementing the logic component may send a modified routing table to routers W-Z. The modified routing table may be different for one or more of routers W-Z. In other examples, the logic component may be implemented on one or more of routers W-Z. The router(s) implementing the logic component may update their respective routing tables and/or send a command or set of instructions for updating a routing table to the routers W-Z. In yet other examples, the logic component may be implemented on a central server/device that is not pictured in environment 500. The central server/device may be configured to communicate directly with one or more of servers A-E and/or routers W-Z. The central server/device may send commands/instructions for performing routing table updates to one or more of routers W-Z. Alternately (or additionally), the central server/device may cause one or more of servers A-E not to advertise to one or more of routers W-Z. For instance, the central server/device may edit (or cause the editing of) a BGP community associated with one or more of servers A-E and/or routers W-Z.

In aspects, the routing tables may be modified in response to one or more conditions. For example, a device upon which the logic component is implemented may detect or be notified of a DDoS attack (or other cyber-attack). In response to detecting or being notified of the DDoS attack, the logic component may evaluate the network data associated with the DDoS attack to identify content-providing devices (such as servers A-E) that may potentially be impacted. Upon identifying one or more potentially impacted devices, the logic component may identify network devices (such as routers W-Z) that provide routes to the potentially impacted devices. The routing tables of the identify network devices may then be modified as described above.

After the modification of the routing tables of routers W-Z, each of the respective routing tables comprises routing destinations for only a subset of servers A-E assigned to the common destination IP address. For example, the routing table for router W comprises routing destinations for servers A and B that are prioritized in the order: server A, server B; the routing table for router X comprises routing destinations for servers B and C that are prioritized in the order: server B, server C; the routing table for router Y comprises routing destinations for servers D and C that are prioritized in the order: server D, server C; and the routing table for router Z comprises routing destinations for servers E and A that are prioritized in the order: server E, server A. As such, while all five servers A-E may remain assigned to the common destination IP address, the routers W, X, Y, and Z may be dynamically modified to route traffic only to a subset of servers A-E.

In environment 500, when one of servers A-E becomes unavailable, the corresponding router(s) continue to send the network traffic to any available server(s) in the subset of servers in their respective routing tables. Although the increased network traffic may eventually cause one or more of the available servers in the subset of servers to become unavailable, the failure event will not propagate beyond the subset of servers. For example, during a DoS or DDoS attack, router W may receive a large, sustained volume of network traffic intended for the destination IP address of servers A-E. Based on the routing priority of network routes listed in the routing table of router W, the received network traffic may be primarily (if not entirely) routed to server A. Eventually, the sustained network traffic may cause server A may become unavailable. In response to server A becoming unavailable, router W may begin routing the received network traffic of router W to server B. Eventually, the sustained network traffic may also cause server B to become unavailable. However, unlike environment 100 of FIG. 1, the routing table of router W does not include network routes to servers C, D, or E. As a result, the DoS/DDoS attack is unable to impact servers C, D, or E via the network traffic received by router W.

FIG. 6 illustrates an exemplary suitable operating environment for the routing scope restriction techniques described herein. In its most basic configuration, operating environment 600 typically includes at least one processing unit 602 and memory 604. Depending on the exact configuration and type of computing device, memory 604 (storing, instructions to perform the techniques disclosed herein) may be volatile (such as RAM), non-volatile (such as ROM, flash memory, etc.), or some combination of the two. This most basic configuration is illustrated in FIG. 6 by dashed line 606. Further, environment 600 may also include storage devices (removable, 608, and/or non-removable, 610) including, but not limited to, magnetic or optical disks or tape. Similarly, environment 600 may also have input device(s) 614 such as keyboard, mouse, pen, voice input, etc. and/or output device(s) 616 such as a display, speakers, printer, etc. Also included in the environment may be one or more communication connections 612, such as LAN, WAN, point to point, etc. In embodiments, the connections may be operable to facility point-to-point communications, connection-oriented communications, connectionless communications, etc.

Operating environment 600 typically includes at least some form of computer readable media. Computer readable media can be any available media that can be accessed by processing unit 602 or other devices comprising the operating environment. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory medium which can be used to store the desired information. Computer storage media does not include communication media.

Communication media embodies computer readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, microwave, and other wireless media. Combinations of the any of the above should also be included within the scope of computer readable media.

The operating environment 600 may be a single computer operating in a networked environment using logical connections to one or more remote computers. The remote computer may be a personal computer, a server, a router, a network PC, a peer device or other common network node, and typically includes many or all of the elements described above as well as others not so mentioned. The logical connections may include any method supported by available communications media. Such networking environments are commonplace in offices, enterprise-wide computer networks, intranets and the Internet.

The embodiments described herein may be employed using software, hardware, or a combination of software and hardware to implement and perform the systems and methods disclosed herein. Although specific devices have been recited throughout the disclosure as performing specific functions, one of skill in the art will appreciate that these devices are provided for illustrative purposes, and other devices may be employed to perform the functionality disclosed herein without departing from the scope of the disclosure.

This disclosure describes some embodiments of the present technology with reference to the accompanying drawings, in which only some of the possible embodiments were shown. Other aspects may, however, be embodied in many different forms and should not be construed as limited to the embodiments set forth herein. Rather, these embodiments were provided so that this disclosure was thorough and complete and fully conveyed the scope of the possible embodiments to those skilled in the art.

Although specific embodiments are described herein, the scope of the technology is not limited to those specific embodiments. One skilled in the art will recognize other embodiments or improvements that are within the scope and spirit of the present technology. Therefore, the specific structure, acts, or media are disclosed only as illustrative embodiments. The scope of the technology is defined by the following claims and any equivalents therein.

What is claimed is:

1. A system comprising:
at least one processor; and
memory, operatively coupled to the at least one processor, the memory comprising computer executable instructions that, when executed by the at least one processor, cause the system to perform a method, the method comprising:
receiving, at a first device, a message, wherein the message indicates a destination IP address that is an anycast address common between the first device and a second device;
evaluating network data to identify one or more indicators of a potential failure or a potential performance degradation of at least one of the first device or the second device;
in response to identifying the one or more indicators, identifying one or more network devices associated with at least one of the first device or the second device;
identifying one or more routing table modifications to be applied to the one or more network devices based on the one or more indicators; and
causing the one or more routing table modifications to be applied to the one or more network devices.

2. The system of claim 1, wherein the network data comprises at least one of network traffic, network performance data, or device performance data.

3. The system of claim 1, wherein evaluating the network data comprises providing the network data to an automated logic system.

4. The system of claim 3, wherein the automated logic system identifies the one or more indicators using at least one of:
a decision tree;
logistic regression;
a support vector machine (SVM);
a k-nearest-neighbor (KNN) algorithm;
a neural network;
a Naïve Bayes classifier;
linear regression; or
k-means clustering.

5. The system of claim 1, wherein the one or more indicators are derived from at least one of:
a number of network requests received from a source IP address or geographic region;
a number of network requests received by the one or more network devices or the first device;
network request trends;
a system load of the one or more network devices or the first device;
web resource availability;
failover or imminent failure messages; or
network latency.

6. The system of claim 1, wherein identifying one or more network devices comprises at least one of:
evaluating the network data using a network trace utility;
evaluating a routing table of at least one of the one or more network devices; or
evaluating recorded network traffic log data.

7. The system of claim 1, wherein identifying one or more routing table modifications to be applied to the one or more network devices comprises determining a network route to at least one of the first device or the second device is to be disabled for at least one of the one or more network devices.

8. The system of claim 1, wherein the one or more routing table modifications to be applied to the one or more network devices are further based on at least one of routing logic or routing metrics associated with at least one of the one or more network devices.

9. The system of claim 8, wherein the routing metrics comprise at least one of:
hop count;
path length;
path speed;
bandwidth;
latency;
path cost;
path reliability; or
system load.

10. The system of claim 8, wherein the routing logic is based a border gateway protocol (BGP) associated with the one or more network devices.

11. The system of claim 1, wherein causing the one or more routing table modifications to be applied to the one or more network devices comprises:
stopping, by the first device, advertisement of the destination IP address, wherein stopping advertisement of the destination IP address causes a network route to at least one of the first device or the second device to be disabled by the one or more network devices.

12. The system of claim 1, wherein causing the one or more routing table modifications to be applied to the one or more network devices comprises:
providing, by the first device, the one or more routing table modifications to the one or more network devices; and
receiving, from the one or more network devices, an indication that the one or more routing table modifications have been applied to one or more routing tables of the one or more network devices.

13. The system of claim 1, wherein, prior to causing the one or more routing table modifications to be applied to the one or more network devices:
a first network device of the one or more network devices includes a first routing table that comprises a first route to the first device and a second route to the second device; and
a second network device of the one or more network devices includes a second routing table that comprises the first route to the first device and the second route to the second device.

14. The system of claim 13, wherein, in response to causing the one or more routing table modifications to be applied to the one or more network devices:
the first routing table of the first network device does not comprise at least one of the first route to the first device or the second route to the second device; and
the second routing table of the second network device does not comprise at least one of the first route to the first device or the second route to the second device.

15. A first network device comprising:
at least one processor; and
memory, operatively coupled to the at least one processor, the memory comprising computer executable instructions that, when executed by the at least one processor, causes the first network device to perform a method comprising:
receiving a message, wherein the message indicates a destination IP address that is an anycast address common between a first endpoint device and a second endpoint device;
evaluating network data to identify one or more indicators of a potential failure or a potential performance degradation of at least one of the first endpoint device or the second endpoint device;
in response to identifying the one or more indicators of network behavior, identifying one or more routing table modifications to be applied to a routing table of the first network device, wherein the one or more routing table modifications restrict or remove a route to at least one of the first endpoint device or the second endpoint device; and
dynamically applying the one or more routing table modifications to the routing table.

16. The first network device of claim 15, wherein evaluating the network data to identify one or more indicators comprises:
incrementing one or more counters based on the one or more indicators;
comparing the incremented one or more counters to a threshold value; and
when the incremented one or more counters meet or exceed the threshold value, classifying the corresponding one or more indicators as indicative of the potential failure or the potential performance degradation.

17. The first network device of claim 15, wherein, prior to dynamically applying the one or more routing table modifications to the routing table:
the routing table comprises at least a first route to the first endpoint device and a second route to the second endpoint device.

18. The first network device of claim 17, wherein, in response to dynamically applying the one or more routing table modifications to the routing table:
at least one of the first route to the first endpoint device or the second route to the second endpoint device is restricted or removed from the routing table.

19. The first network device of claim 15, wherein the computer executable instructions, when executed by the at least one processor, perform the method further comprising:
transmitting the one or more routing table modifications to a second network device associated with at least one of the first endpoint device or the second endpoint device, wherein the one or more routing table modifications cause the second network device to restrict or remove the route to at least one of the first endpoint device or the second endpoint device.

20. A method comprising:
receiving, at a first device, a message, wherein the message indicates a destination IP address that is an anycast address common between the first device and a second device;
evaluating network data to identify one or more indicators of a potential failure or a potential performance degradation of at least the first device;
in response to identifying the one or more indicators, identifying one or more network devices associated with the first device;
identifying a routing table modification to be applied to at least one of the one or more network devices based on the one or more indicators; and
stopping, by the first device, advertisement of the destination IP address to the at least one of the one or more network devices based on the routing table modification.
